(19) United States
(12) Patent Application Publication
(10) Pub. No.: US 2009/0059744 A1
(43) Pub. Date: Mar. 5, 2009

(54) OPTICAL DISC ACTUATOR CONTROL

(75) Inventors: Antonius Leonardus Johannes Dekker, Eindhoven (NL); Jacques Schreurs, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/718,812

(22) PCT Filed: Nov. 10, 2005
(86) PCT No.: PCT/IB05/53704

§ 371 Date: May 8, 2007

(30) Foreign Application Priority Data
Nov. 15, 2004 (EP) 04105757.1

(51) Int. Cl. G11B 7/00

(52) U.S. Cl. 369/44.32; G9B/7

(57) ABSTRACT

An optimizing of a gain in a servo control loop (21) of an optical drive is performed for the control of an actuator for focusing and tracking a laser beam (10) for reading or writing data from/to optical discs (1), wherein the actuator is controlled by a servo controller (20) in the control loop (21), by means of an algorithm performing the steps: predetermining a reference oscillation level for the servo control loop (21), iteratively checking if a power output from the control loop (21) used as an dissipation level value is less than the reference oscillation level, increasing the gain in the servo control loop in each iteration step until said dissipation level value is equal to or greater than the reference oscillation level and then decreasing the gain in the control loop by a margin value.

The present invention refers to optical drives for reading or writing data from/to optical discs, wherein an actuator for focusing and tracking a laser beam is controlled by a servo controller in a feedback loop. Particularly, the invention has as an object to control gain in the servo controlled loop.

Digital information is read from an optical disk or written on an optical disc along a track on the optical disc by use of an optical drive. A focus actuator in the optical drive is used to focus a laser spot onto the optical disc. The laser spot is provided by a laser beam focused by means of an object lens, which focuses the laser beam onto a data storing layer of the disc. As an example, a focusing actuator coil drives the object lens so that the object lens is focusing a focal point of the laser beam on a data storing layer of the disc. A second coil, a tracking actuator coil, drives a tracking object lens, so that the laser beam is traced along the track of the disc.

In an optical drive a servo system is used to focus the focal point of the laser beam, the laser spot, onto the data storing layer of the disc. A control loop for controlling said servo system is called the control loop focus. To guarantee a proper optical drive performance the focus control loop must be closed. An error signal for controlling the guidance of the laser beam in the servo system can be obtained from light reflected back from the data storing layer to a detector on a sledge carrying a light source for the laser beam.

The control loop of an actuator in an optical disc has a certain gain that is set in relation to a speed with which the disc is rotated. The loop gain depends on a lot of factors, like temperature and disc area that is to be read or written. In order to control the loop gain some control algorithms are known.

The control loop gain determines the bandwidth of the control and must be set in relation to the rotational disc speed. At high speeds of the disc (48× for CD, 16× for DVD and 4× for BD) the control loop of the actuator servo controller has a loop gain that is critical. Higher gains will cause oscillations in the loop. Because of loop gain variations caused by some reasons, such as detector sensitivity, differences between recorded and non-recorded areas of the optical disc, the control gain is, as already stated, set to a value that is typically and constantly lower than the maximal value in order to avoid oscillations in the control loop.

An automatic gain control can be achieved by applying a periodic signal having a frequency about equal to the bandwidth of the servo loop. A measured response to the applied signal can be used to control the loop gain. This gain control is not constantly active during reading or writing discs. Typically, a check is made initially and repeatedly, if necessary, later in time during reading or writing data.

JP-053 14504 describes an optical information and reproducing device. The object of the device described in this document is to prevent oscillation of a focusing control loop of a servo control system by setting the loop gain of the servo system to a stabilized value. In the servo control system including the control loop a compensation controller is monitored by an A/D converter. When focusing control is in a normal state the output of the compensation controller is a signal with a nearly fixed level. A computer checks the absolute value of the amplitude of the AC component of the data fed to the converter and processes the data for comparing an obtained value with a preset value. If the obtained value is equal or below the preset value the device is judged to operate normal. If, on the other hand, the obtained value is greater than the preset value the operation is judged to be abnormal, whereupon the gain of a variable gain amplifier is set to a lower value and the output of the compensation controller is reduced until the oscillation is stopped and a proper gain is accomplished.

A drawback of the prior art device is that the monitor of the gain level is not continuous. It is activated only when an oscillation of the control loop occurs. This implies that the loop gain level during normal operation of the device, which can last during relatively long periods may be to low and non-optimized.

One object of the invention is to suggest a method and a device including an algorithm that controls the servo control loop to attain a maximal gain.

According to an aspect of the invention there is provided a method as specified in claim 1.

According to a further aspect of the invention there is provided a device as specified in the independent device claim.

Further embodiments of the invention are disclosed in the subclaims.

One feature of the invention is that the maximal control gain is searched continuously or automatically repeated by iteratively increasing the control loop gain until oscillation starts in the control loop. The oscillation is detected by measuring the power dissipation in the actuator. At the critical moment where the gain is of a level such that oscillation starts, the gain is reduced by a certain margin, like 25%, as an example, but a percentage between 10% to 50% is convenient.

At start-up the loop gain might be adjusted with regular AGC (automatic Gain Control). Later when the disc is running the described mechanism can be started with fixed time intervals, at temperature changes or at read/write transitions. These are all reasons for loop gain changes and caused by changed actuator sensitivity or changed sensitivity of a signal detecting oscillation in the loop.

The device according to the invention includes a dissipation measuring device for measuring the output of power from the servo controller feeding the actuator with power. According to one embodiment the controller for controlling the gain in the control loop includes a circuit for squaring samples of the electrical control signal (the output) from the servo controller to the actuator. The resulting signal after squaring is filtered, whereupon the amplitude of the filtered signal is compared to a predefined reference oscillation level for detecting oscillation in the control loop. Said amplitude of the squared and filtered dissipation signal representing the present dissipation level is checked, iteratively in a loop, if said present dissipation level is lower than the dissipation level where the reference oscillation level is reached. The gain in the servo control loop is then increased stepwise, in each iteration step, until the present dissipation level is equal to or greater than the dissipation level where the reference oscillation level is reached.

The measuring device is adapted to measure the control value to the actuator.

An advantage of the invention is that the control algorithm used by the controller sets a maximal gain in the control loop during all circumstances, whereby there is no need for a fixed gain level.

These and other aspects of the invention will be apparent from and elucidated with reference to the embodiment(s) described hereinafter.

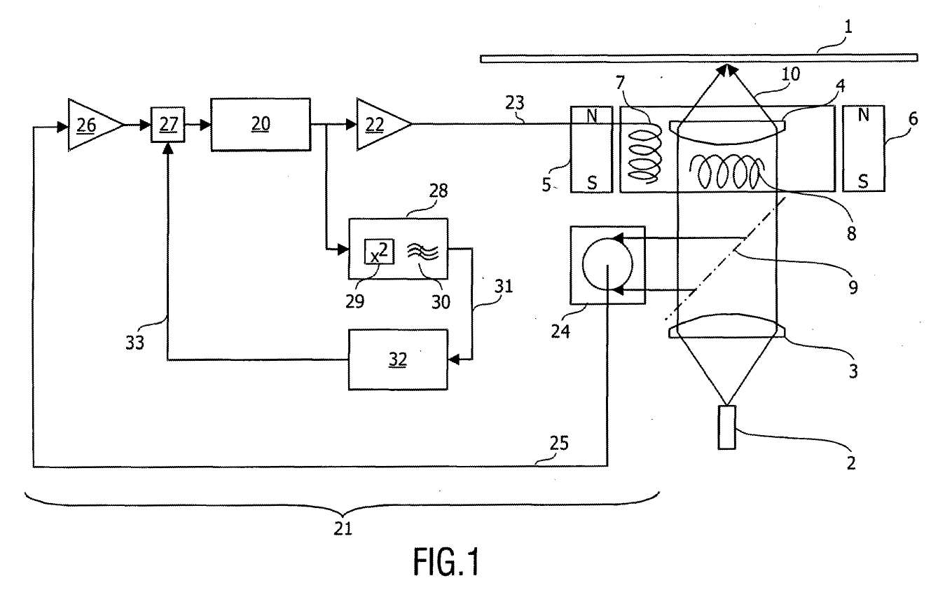

FIG. 1 discloses a schematical view of the integral parts of a focus controller and the actuator of an optical drive according to one example of the invention. The radial controller is not shown because it consists of the same components.

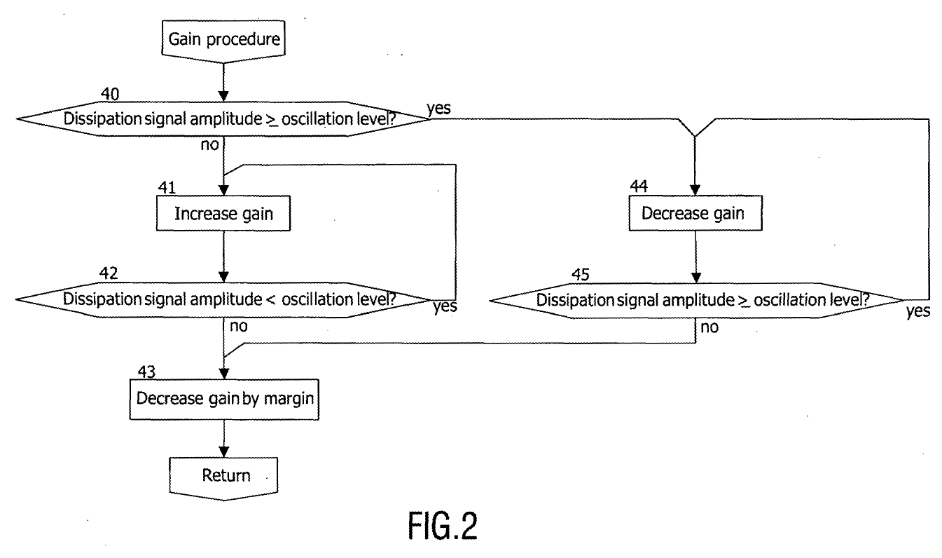

FIG. 2 discloses a flow chart for an algorithm for the procedure to control the gain in the control loop according to an aspect of the invention.

A number of embodiments for performing the method according to the invention will be described in the following supported by the enclosed drawings.

A schematical view of the integral parts of a focus control loop and the actuator of an optical drive according to the invention is depicted in FIG. 1.

An optical disc is represented by FIG. 1. A laser light source 2 directs light towards the optical disc 1. The laser light from the laser light source 2 is focused to a spot on a track of the disc 1 by means of lenses 3, 4. An actuator adjusts the lenses 3, 4 into a correct position to focus said spot on the disc. Said actuator comprises further, as in this example, fixed magnets 5, 6, a focusing coil 7, a radially tracking coil 8, a semi-transparent mirror 9. The focusing actuator coil 7 drives the object lens 3 so that the object lens 3 is collecting the laser light to a laser beam 10 and focusing a focal point of the laser beam 10 on a data storing layer of the disc 1. A second coil, the tracking actuator coil 8, drives the tracking object lens 4, so that the laser beam 10 is traced radially along the track of the disc.

A servo controller 20 in a control loop 21 controls the focusing and the tracking of the actuator laser beam 10 on the optical disc 1. An output signal from the servo controller 20 is amplified in a power amplifier 22 and is sent by flexible wires as a control signal 23 to the focusing coil 7 of the actuator. The radial controller consists of the same parts and is connected to coil 8 of the actuator.

To guarantee a proper optical drive performance the focus control loop 21 must be closed. An error signal for controlling the guidance of the laser beam in the servo system is obtained from light reflected back from the data storing layer of the optical disc 1 to a photo detector 24 on a sledge carrying the light source 2 for the laser beam 10. The detector signal 25 is transported back by means of flexible wires in the control loop carrying said detector signal 25 as an error signal to a preamplifier 26. The error signal is then multiplied in a multiplier 27, whereupon the error signal is closing the loop by being forwarded to the input of the servo controller 20.

According to one aspect of the invention the output signal from the servo controller 20 is also forwarded to a measuring device 28, which in this embodiment measures the dissipation (defined below) generated in the actuator focusing coil. Said dissipation signal can be used as a signal indicative of oscillation occurring in the control loop 21. This is achieved according to this embodiment of the invention by squaring the signal in a squaring circuit 29, whereupon the signal is filtered in a filter 30.

If the amplitude of the filtered signal 31 exceeds or equals a predetermined level value, oscillation is considered to prevail in the control circuit 21.

In a controller 32 said predetermined oscillation value is stored and compared to the measured value of the squared and filtered dissipation signal 31, which is inputted to the controller 32. This filtered dissipation signal 31 is used as a dissipation level value. The controller is programmed with an algorithm, which is described, according to this embodiment, in the form of a flow chart in FIG. 2. Depending on the outcome of the performed algorithm, the controller 32 sets the gain in the control loop 21 by controlling the gain multiplier 27 by means of a gain control signal 33.

The procedure for control of the gain in the control loop 21 performed in the controller 32 follows an algorithm according to the flow chart in FIG. 2. In a first step the actual dissipation value composed by the value of the filtered signal 31 is compared to the predetermined oscillation level value in a process step 40. If the actual dissipation value is lower than the predetermined oscillation level value, the controller 32 increases the gain in the control loop 21 as indicated in process step 41. Once again, in an iterative procedure, the predetermined value is compared to the actual dissipation value in step 42. If oscillation is still not occurring, the gain is increased again in step 41 in the iterative loop. The iteration continues with step-wise increase gain in the iterative loop composed by steps 41 and 42, until oscillation occurs, which is indicated in step 42, in that the actual dissipation value exceeds the predetermined oscillation level value. When this happens, the controller 32 decreases in step 43 the gain in the control loop 21 with a margin amount via gain control signal 33.

If, at the first step 40 in the process, oscillation is already indicated to prevail, controller 32 decreases in a process step 44 the gain in the control loop 21 in a second iteration loop, which further includes step 45 where the actual dissipation level is compared to the predetermined level to decide if the performing of the iteration of steps 44 and 45 should continue. When oscillation is indicated to stop, the algorithm continues to step 43. The controller 32 can be programmed to run the algorithm repeatedly or only during changing conditions. As examples, the algorithm can be set to run initially and after expected gain variation or after a transition of status, like reading recorded or non-recorded areas on an optical disc.

By means of the algorithm the gain is iteratively adjusted until there is just no oscillation. Then the gain is reduced with a certain value in order to have some gain margin. A possible problem is that optical discs with high acceleration error give high dissipation values. Such high acceleration errors occur when a disc has unflatness, which may require high control voltages for the actuator, especially at high disc speeds. So, if such a disc is present the dissipation is already high. Therefore the reference oscillation value should be chosen high as well, by that no false oscillation indication will occur.

The controller 32 is programmed to perform the algorithm for setting the gain in the control loop timely according to preset intervals or following defined events.

The control gain amount may according to one embodiment consist of a set of possible gain values. Initially, the highest gain value is set. If oscillation is still detected lower gain values can be set until oscillation does not occur.

The margin value can be a fixed value in an interval between 10 and 50 percent and as a preferred embodiment a margin value of 25% is chosen.

The invention can be applied to servo controller for actuators in optical disc drives for high speeds.

The terms comprising and including in the claims do not exclude other elements or steps. The articles a or an do not exclude a plurality of elements.

### Definitions:

Connection of a disc to a drive means one of:

a disc is inserted into the drive,

a drive is powered up when an (unknown) disc is already present in said drive or

a disc present or inserted into an auxiliary unit is coupled to said drive for r/w of the disc.

Dissipation is (P=Û2/R=I*R) generated in the focus actuator focus coils. These coils form the electromagnetic motor for the actuator together with magnets. Generally the magnets are part of the fixed world, in this case the sledge, and the coils are part of the moving part of the actuator which also carries the objective lens. The focus dissipation can be measured in the drive by means of squaring the focus controller output and correcting the result for end stage drivers and focus coil resistance.

1. A method for optimizing a gain in a servo control loop of an optical drive, wherein an actuator for focusing and radially tracking a laser beam for reading or writing data from/to optical discs is controlled by a servo controller in the control loop, comprising the steps of:
obtaining a reference oscillation level for the servo control loop,
measuring a dissipation level being a squared power output from the control loop,
iteratively checking if a present dissipation level is lower than a dissipation level where the reference oscillation level is reached,
increasing the gain in the servo control loop in each iteration step until the present dissipation level is equal to or greater than the dissipation level where the reference oscillation level is reached and then
decreasing the gain in the control loop by a margin value.

2. The method according to claim 1, wherein said measuring of the dissipation level is performed as a measure of the squared and filtered output voltage from the servo controller (20).

3. The method according to claim 2, wherein said dissipation level is the amplitude of the squared and filtered output voltage.

4. The method according to claim 1, wherein the margin value is a percentage between 10 and 50 percent.

5. The method according to claim 4, wherein the margin value is around 25%.

6. The method according to claim 1, wherein the margin value is a value from a set of values, wherein stepwise margin values are chosen from a highest to lower margin values from said set of values until oscillation is not occurring.

7. The method according to claim 1, wherein the controller 32 is programmed to perform the method steps of claim 1 or timely according to preset intervals or following defined events.

8. A device for optimizing a gain in a servo control loop (21) of an optical drive comprising:
an actuator for focusing and radially tracking a laser beam (10) for reading or writing data from/to optical discs (1) connected to the optical drive,
a servo controller (20) in said control loop (21) controlling said actuator,
characterized in that the device comprises:
measuring means (28) for measuring a dissipation level being a squared power output from the servo controller (20) to the actuator,
comparing means for comparing said dissipation level with a predetermined reference oscillation level for the control loop (21),
control loop gain control means for increasing or decreasing the gain in the control loop (21) and
a controller (32) for: monitoring and optimizing the control loop gain by iteratively checking if the present dissipation level is lower than a dissipation level where the reference oscillation level is reached, increasing the gain in the servo control loop (21) in each iteration step until the present dissipation level is equal to or greater than the dissipation level where the reference oscillation level is reached and then decreasing the gain in the control loop (21) by a margin value.

9. The device according to claim 8, wherein the measuring means (28) includes a signal squaring circuit (29).

10. The device according to claim 9, wherein the measuring means (28) includes a filter (30) for filtering the signal squared in the squaring circuit (29).

11. The device according to claim 8, wherein the controller (32) sets the gain in the control loop (21) by means of a gain multiplier (27) in dependence of the result of the comparison between the predetermined oscillation level and the, measured dissipation level.

12. An optical disc drive for reading/writing an optical disc (1) including the device according to claim 8.

13. An optical disc drive for reading/writing an optical disc (1) for performing the method according to claim 1.
